(19) United States
(12) Patent Application Publication
(10) Pub. No.: US 2005/0146505 A1
(43) Pub. Date: Jul. 7, 2005

(54) Ergonomic keyboard tilted forward and to the sides

(76) Inventor: Yaron Nahum Mandel, Thornhill (CA)

Correspondence Address: Yaron Nahum Mandel, 14 Nottinghill Road, Thornhill, ON, L3T 4X9, CA

(21) Appl. No.: 10/751,486

(22) Filed: Jan. 6, 2004

(51) Int. Cl. G09G 5/00

(52) U.S. Cl. 345/168

(57) ABSTRACT

An ergonomic keyboard having Dvorak key layout. The keys are arranged along a V or U shape. The keyboard has a hand rest/wrist rest. The keyboard is tilted forward and to the sides.

### CROSS REFERENCE TO RELATED APPLICATIONS

Not applicable

### STATEMENT REGARDING FEDERALLY SPONSORED RESEARCH OR DEVELOPMENT

Not applicable

### INCORPORATION BY REFERENCE OF MATERIAL SUBMITTED ON A COMPACT DISC

Not applicable

### BACKGROUND OF THE INVENTION

1. Field of the Invention

The invention relates to ergonomic keyboards for computers and terminals.

2. Description of Related Art

In order to address the problem of repetitive strain injury (RSI), such as carpal tunnel syndrome, caused by the use of keyboards, manufacturers are designing ergonomic keyboards that are more comfortable to use, and that allow the user's hands to be more relaxed. A number of approaches have been used.

One approach involves arranging the keys along a flat V or U shape instead of a straight line. The keys are arranged either in one continuous group along this shape, or in two groups. The advantage is that the angle of the user's arms is more natural and therefore more relaxed.

Sometimes the keyboard also has a hand rest or a wrist rest. For example, see Camacho (U.S. Pat. No. 6,467,979 and others).

Another approach involves the use of the Dvorak key layout (ANSI standard INCITS 207-1991 [R2002]) instead of the more common QWERTY key layout. The advantage is that the most commonly used keys are located on the home row, which minimizes finger travel and extension. For example, see Zagnoev (U.S. Pat. No. 5,936,555) and Romberg (U.S. Pat. No. 5,166,669). A number of keyboards with Dvorak key layout are available on the market, for example from Dvorty Boards and from Finger Works.

Another approach involves placing the keys below the level of the user's palm, or tilted forward and downwards away from the user. This is instead of the usual arrangement where the keyboard is either tilted upwards toward the user, or it is flat on the desk. The advantage is that the user's palm slopes downwards along the surface of the keys, so it continues along the line formed by the user's arm from the shoulder downwards. Therefore the user's palm is more relaxed and comfortable. For example, see Hargreaves (U.S. Pat. No. 6,005,496 and others). The Contoured keyboard from Kinesis Corporation also places the keys below the user's palm. Mandel (U.S. patent application Ser. No. 10/315,212) discloses a keyboard with Dvorak key layout, that is tilted downward and forward, away from the user's hands. The keys are split into 2 groups arranged in a U or V shape. The keyboard has a hand rest/wrist rest.

Danziger (U.S. Pat. No. 5,426,449) discloses a pyramid-shaped keyboard. The character keys are placed on two side panels that are tilted downwards to the sides.

Each one of these approaches has merit. They are all useful in creating keyboards where the user's hands are relaxed and comfortable, so as to decrease the occurence of repetitive strain injuries (RSI) caused by keyboard use. Combining a number of these approaches in one keyboard will create a superior ergonomic keyboard.

### BRIEF SUMMARY OF THE INVENTION

This invention is a keyboard which combines a number of approaches described in the prior art section to solve the problem of repetitive strain injury caused by the use of keyboards. The keyboard has a Dvorak key layout. The keys are arranged in a V or U shape. It has a hand rest/wrist rest. It is tilted both forward and to the sides. The result is a superior ergonomic keyboard which keeps the user's hands as relaxed and comfortable as possible, helping to minimize repetitive strain injuries.

### BRIEF DESCRIPTION OF THE SEVERAL VIEWS OF THE DRAWINGS

FIG. 1 is one embodiment of the keyboard, viewed from top looking down.

FIG. 2 is the same keyboard as in FIG. 1, viewed from opposite the user.

FIG. 3 is another embodiment of the keyboard, viewed from top looking down.

FIG. 4 is the same keyboard as in FIG. 3, viewed from opposite the user.

FIG. 5 is the Dvorak key layout used for the character keys in the keyboard.

FIG. 6 is one row of keys, viewed from the user's side, showing how the keyboard is tilted to the sides. Each half of the keyboard is tilted from the center downwards to its side.

FIGS. 7, 8, 9 and 10 are all side views of the profile of the keyboard, showing how the keyboard is tilted forward. Only the keys nearest to the side are shown.

FIG. 7 is a side view of the keyboard without a hand rest/wrist rest.

FIG. 8 is a side view of the keyboard with a hand rest/wrist rest.

FIG. 9 is a side view of the keyboard with another kind of hand rest/wrist rest.

FIG. 10 is a side view of the keyboard with a concave profile and with a hand rest/wrist rest.

### REFERENCE NUMERALS IN DRAWING FIGURES

1—Hand rest/wrist rest.
2—Hand rest/wrist rest.
3—Apex or ridge, the top line where the two sides of the keyboard meet.
4—Another view of the apex or ridge, same as numeral 3 above.
5—Another view of the apex or ridge, same as numerals 3 and 4 above.

### DETAILED DESCRIPTION OF THE INVENTION

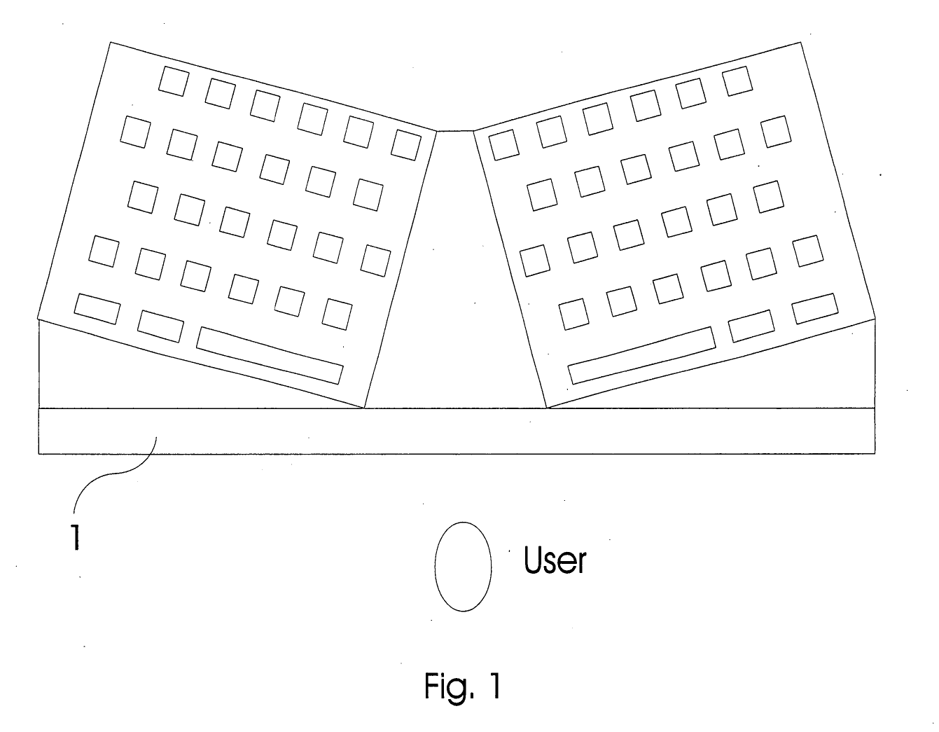

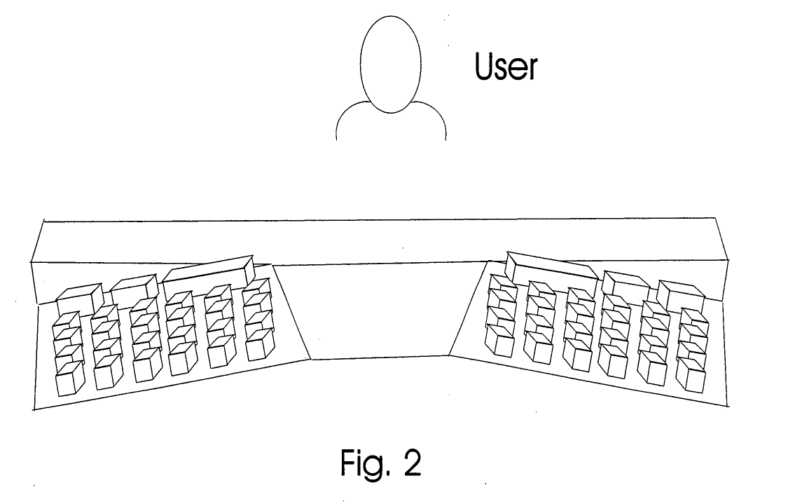

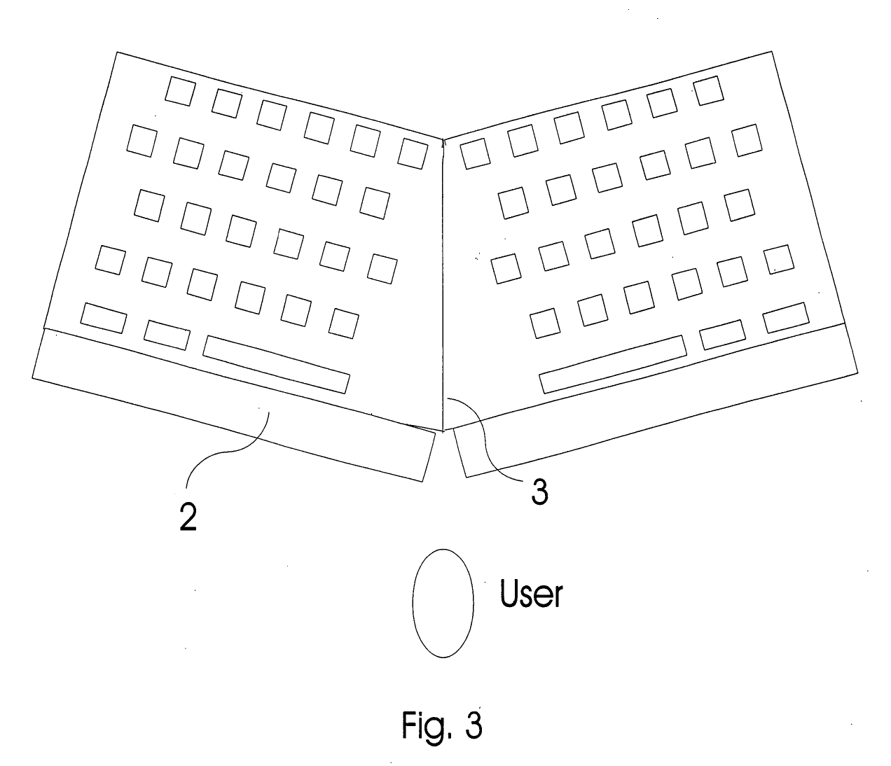

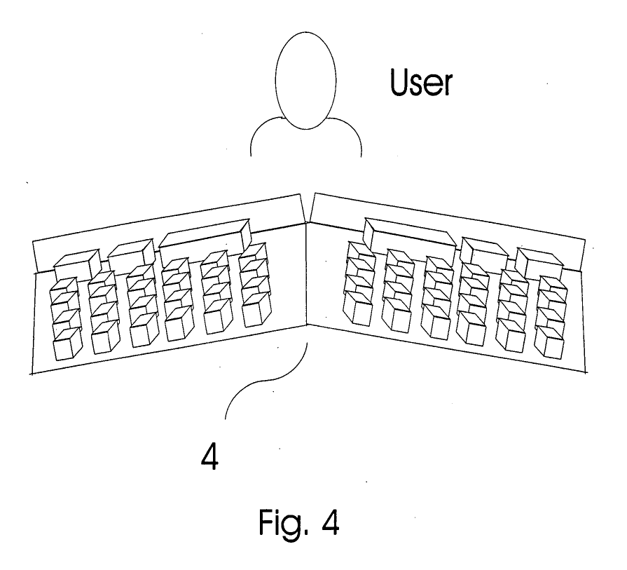

One embodiment of the keyboard is shown in FIG. 1, viewed from top looking down. Another view of the same embodiment is shown in FIG. 2, viewed from opposite the user. FIGS. 3 and 4 are two views of a second embodiment of the keyboard. These are examples of possible embodiments. Many other implementations are possible.

This keyboard combines a number of ergonomic features.

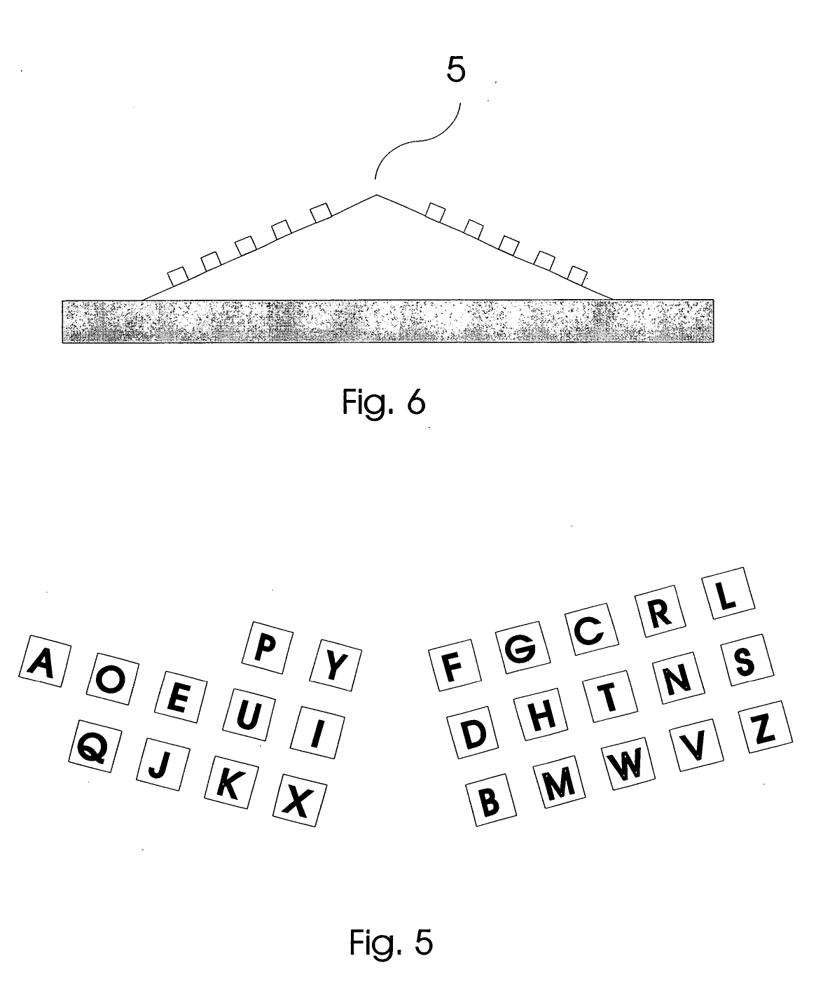

In the preferred embodiment, the character keys are arranged in the Dvorak key layout instead of the usual QWERTY. The keys are arranged along an imaginary V or U shape. FIG. 5 shows the character keys arranged in two groups to form a V shape. The keys can also be arranged in one group and in a U shape.

The character keys in the Dvorak key layout can be split in two groups using the groups as shown in FIG. 5, or split in two different groups. FIG. 5 shows only character keys. Other keys, such as numeric keys, punctuation keys, arrow keys, function keys etc. are not shown. Placement of these keys will vary in different implementations. The implementations do not necessarily adhere to ANSI standard INCITS 207-1991 (R2002).

The preferred embodiment of the keyboard has character keys in the layout shown in FIG. 5. FIG. 5 shows the keys arranged in straight rows and columns. This is not necessarily the case. In most implementations the columns will not be vertical as shown. For example, S will not generally be straight above Z, and E will not be exactly above J.

Refer to FIGS. 3 and 4. The keyboard has a ridge or apex in the middle, and each half is tilted to its own side, starting from the apex/ridge downwards. This is also shown in FIG. 6. The ridge/apex is denoted with numerals 3, 4 and 5 in the figures. (The keyboard in FIGS. 1 and 2 has two ridges/apexes.)

Refer to FIG. 6. The user places his hands on the two sides of the keyboard. Because the two sides are tilted, the user's palm partially faces the desk, and partially faces the other palm.

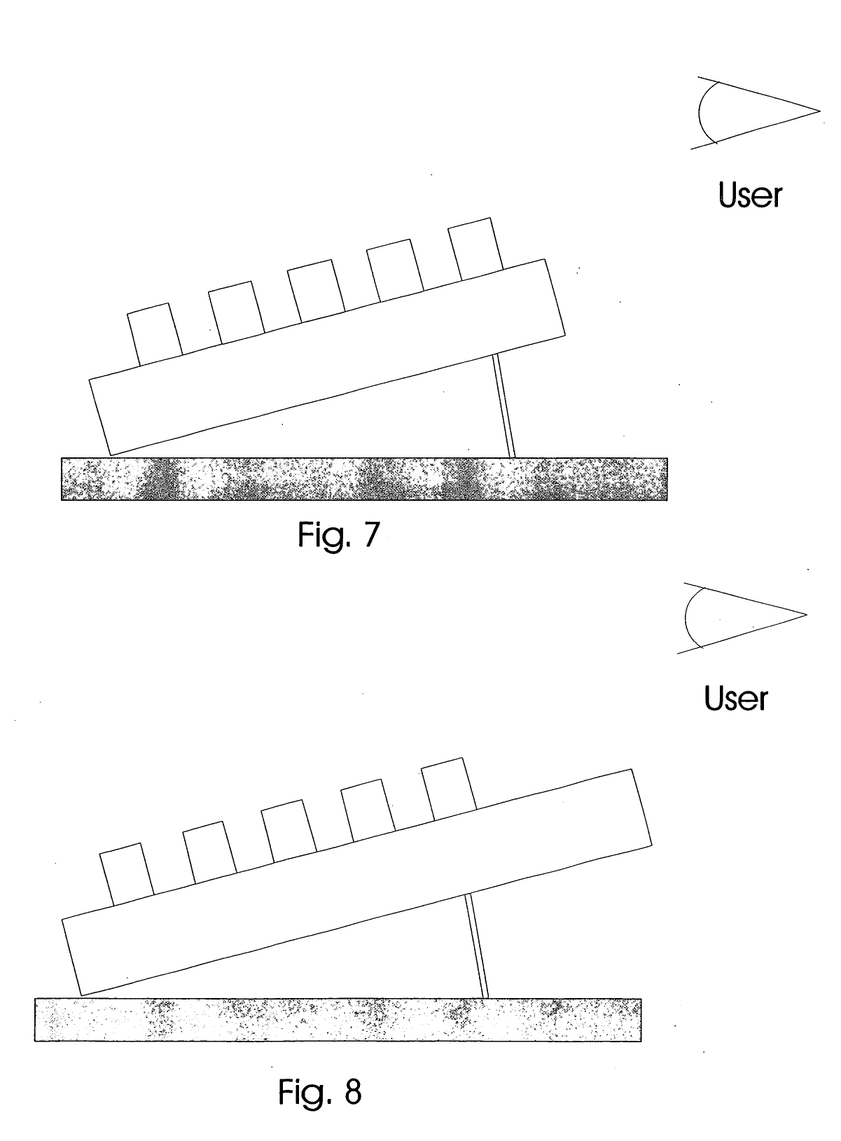

Refer to FIGS. 7, 8, 9, 10. The keyboard is also tilted forward and downward. Because of this tilt, the user's palms partially face the desk, and partially face backwards, toward the user.

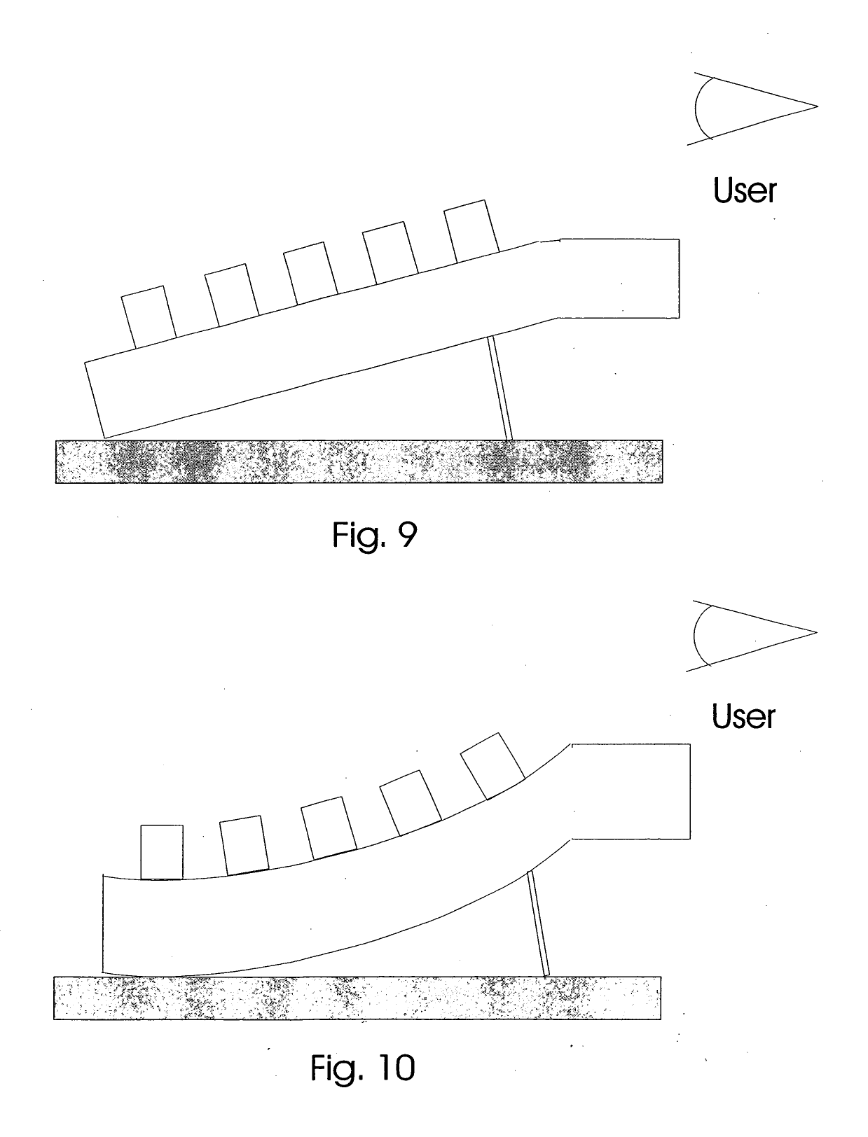

FIG. 7 shows a keyboard without a hand rest/wrist rest. FIGS. 8 and 9 show keyboards with different kinds of hand rests/wrist rests. Refer also to numerals 1 and 2 in FIGS. 1 and 3. The preferred embodiment of the keyboard has a hand rest/wrist rest.

The keyboard can be curved: concave or convex. FIG. 10 shows a concave keyboard with a wrist rest.

The keyboard has a switch that changes the key configuration from Dvorak to QWERTY.

Many modifications and variations are possible with this keyboard, for example:

The keyboard can have QWERTY key layout instead of Dvorak.

The keyboard can be tilted only forward and not to the sides.

The keyboard can be tilted only to the sides and not forward.

The keyboard can be without a hand rest/wrist rest.

The angle of tilt forward can be adjustable.

The angle of tilt to the sides can be adjustable.

The sideways tilt can be achieved using a curved keyboard, convex or concave, instead of a flat tilted keyboard. Alternatively, the keyboard can be both curved and tilted sideways. (In this case, the diagonal sections in FIG. 6 will be curved instead of straight.)

The angle of the two arms of the V or U shape of the key layout can be adjustable.

The distance between the two halves of the keyboard can be adjustable.

The foregoing description of the preferred embodiment of the invention and some possible variations has been presented for the purposes of illustration and description. It is not intended to be exhaustive or to limit the invention to the precise form disclosed. Many modifications and variations are possible. It is intended that the scope of the invention be limited not by this detailed description, but rather by the claims appended hereto.

1. An ergonomic keyboard tilted forward, downward, away from the user's hands.

2. The keyboard in claim 1, wherein said keyboard is tilted downward from the center to the two sides.

3. The keyboard in claim 1, wherein said keyboard has QWERTY character key layout.

4. The keyboard in claim 3, wherein said QWERTY character key layout lies along an imaginary V or U shape.

5. The keyboard in claim 3, wherein said QWERTY character key layout is split into two groups lying along the two sides of an imaginary V or U shape.

6. The keyboard in claim 1, wherein said keyboard further comprising
an upper row of characters comprising from left to right P Y F G C R L,
a middle row of characters comprising from left to right A O E U I D H T N S,
and a lower row of characters comprising from left to right Q J K X B M W V Z;
said keyboard further comprising other keys.

7. The keyboard in claim 6, wherein said rows of characters lie along an imaginary V or U shape.

8. The keyboard in claim 6, wherein said rows of characters are split into two groups lying along the two sides of an imaginary V or U shape,
the left side of said upper row comprising from left to right P Y,
the right side of said upper row comprising from left to right F G C R L,
the left side of said middle row comprising from left to right A O E U I,
the right side of said middle row comprising from left to right D H T N S,
the left side of said lower row comprising from left to right Q J K X, and
the right side of said lower row comprising from left to right B M W V Z.

9. The keyboard in claim 1, wherein said keyboard further comprising a hand rest.

10. The keyboard in claim 1, wherein the profile of said keyboard is curved: concave or convex.

11. An ergonomic keyboard tilted downward from the center to the two sides.

12. The keyboard in claim 11, wherein said keyboard is tilted forward, downward, away from the user's hands.

13. The keyboard in claim 11, wherein said keyboard has QWERTY character key layout.

14. The keyboard in claim 13, wherein said QWERTY character key layout lies along an imaginary V or U shape.

15. The keyboard in claim 13, wherein said QWERTY character key layout is split into two groups lying along the two sides of an imaginary V or U shape.

16. The keyboard in claim 11, wherein said keyboard further comprising
an upper row of characters comprising from left to right P Y F G C R L,
a middle row of characters comprising from left to right A O E U I D H T N S,
and a lower row of characters comprising from left to right Q J K X B M W V Z;
said keyboard further comprising other keys.

17. The keyboard in claim 16, wherein said rows of characters lie along an imaginary V or U shape.

18. The keyboard in claim 16, wherein said rows of characters are split into two groups lying along the two sides of an imaginary V or U shape,
the left side of said upper row comprising from left to right P Y,
the right side of said upper row comprising from left to right F G C R L,
the left side of said middle row comprising from left to right A O E U I,
the right side of said middle row comprising from left to right D H T N S,
the left side of said lower row comprising from left to right Q J K X, and
the right side of said lower row comprising from left to right B M W V Z.

19. The keyboard in claim 11, wherein said keyboard further comprising a hand rest.

20. The keyboard in claim 11, wherein the profile of said keyboard is curved: concave or convex.
